(19) United States
(12) Patent Application Publication
(10) Pub. No.: US 2007/0114460 A1
(43) Pub. Date: May 24, 2007

(54) Charged particle beam processing method and charged particle beam apparatus

(76) Inventors: Masashi Muramatsu, Chiba-shi (JP); Tomokazu Kozakai, Chiba-shi (JP); Ryoji Hagiwara, Chiba-shi (JP)

Correspondence Address: BRINKS HOFER GILSON & LIONE, P.O. BOX 10395, CHICAGO, IL, 60610, US

(21) Appl. No.: 11/546,124

(22) Filed: Oct. 10, 2006

(30) Foreign Application Priority Data
Oct. 21, 2005 (JP) JP2005-307279

(51) Int. Cl. G21K 5/10

(52) U.S. Cl. 250/492.22

(57) ABSTRACT

A reference area that contains a straight contour of a workpiece pattern is irradiated with a beam at a fixed interval to form images. The positions of the contour line in the images before and after a certain time of image formation are compared with each other and the amount of displacement between the positions is calculated. When the workpiece is processed, the beam is applied to the process position corrected by the amount of displacement.

This application claims priority under 35 U.S.C. § 119 to Japanese Patent Application No. JP2005-307279 filed Oct. 21, 2005, the entire content of which is hereby incorporated by reference

### BACKGROUND OF THE INVENTION

The present invention relates to a charged particle beam processing method and charged particle beam apparatus.

When an insulator workpiece is observed or processed by a charged particle beam, such as an ion beam or electron beam, it is known that the workpiece gets charged due to the charged particle beam with which the workpiece is irradiated. If the charged workpiece is irradiated with the charged particle beam to observe or process the workpiece, nonuniform charge distribution on the surface of the charged workpiece may displace an irradiation position of the charged particle beam (drift), resulting in inappropriate observation or processing.

To solve this problem, a method of related art applies the charged particle beam to the pattern of a workpiece, such as a semiconductor device, to drill a hole at a certain point, examines the position of the hole during the process, measures the amount of irradiation position displacement, and then corrects the process position (see, for example, JP-A-7-333120 and JP-B-5-4660).

However, in recent years, as a pattern on a workpiece, such as semiconductor device, becomes finer, drilling a hole at a certain point in the pattern on the workpiece with a charged particle beam as described above may raise concern about a problem affecting the performance of the semiconductor device. For example, as the linewidth of a pattern film on a photomask becomes narrower, drilling a hole in such a fine pattern with a charged particle beam will affect a pattern to be transferred from the mask through exposure. On the other hand, in a method in which the contour of a pattern is used as a reference image, there is a problem that a process position cannot be corrected if there is no pattern in the field of view by which positions both in X and Y directions can be determined, provided that the lateral direction is the X direction and the direction perpendicular thereto is the Y direction.

The invention has been made in view of such situations and aims to provide a charged particle beam processing method and charged particle beam apparatus capable of correcting a process position without forming a mark processed on a workpiece.

### SUMMARY OF THE INVENTION

The invention has been made to solve the above problems and provides a charged particle beam processing method using a charged particle beam apparatus that utilizes charged particle beam irradiation to observe and process a workpiece, wherein the method comprises the steps of: forming a workpiece pattern image based on the detected intensity of secondary charged particles emitted from the workpiece through irradiation of the charged particle beam; in the formed workpiece pattern image, specifying and storing reference areas that contain, among contours of the workpiece pattern, at least two straight portions oriented in different directions, as well as an area to be processed; applying the charged particle beam to the reference areas during the process as required and forming an image of the reference areas based on the detected intensity of secondary charged particles emitted from the reference areas; calculating the amount of positional displacement between the stored image of the reference areas and the image of the reference areas formed during the process; and applying the charged particle beam to the area to be processed corrected by the calculated amount of displacement for processing.

Another aspect of the invention is the charged particle beam processing method, wherein the straight lines oriented in different directions include a lateral straight portion and a longitudinal straight portion, and the method further comprises the step of calculating the amount of longitudinal displacement determined from the displacement of the lateral straight portion and the amount of lateral displacement determined from the longitudinal straight portion.

Another aspect of the invention is the charged particle beam processing method, wherein the method further comprises the steps of: determining intersection points of the straight portions from the stored image of the reference areas and the image of the reference areas formed during the process and calculating the amount of displacement between the intersection points; and applying the charged particle beam to the area to be processed corrected by the calculated amount of displacement between the intersection points for processing.

Another aspect of the invention is the charged particle beam processing method, wherein a plurality of parts of the straight portions are used in the reference areas.

Another aspect of the invention is the charged particle beam processing method, wherein the reference areas contain one lateral straight portion and a plurality of longitudinal straight portions, or a plurality of lateral straight portions and one longitudinal straight portion, and the method further comprises the step of calculating the amount of lateral displacement from the average position of the intersection points of the one lateral straight line and the plurality of longitudinal straight lines, or the amount of longitudinal displacement from the average position of the intersection points of the one longitudinal straight line and the plurality of lateral straight lines.

Another aspect of the invention is the charged particle beam processing method described above, wherein the reference areas contain parallel, lateral straight portions or parallel, longitudinal straight portions and the method further comprises the step of calculating the amount of longitudinal displacement from the average position of the parallel, lateral straight lines or the amount of lateral displacement from the average position of the parallel, longitudinal straight lines.

Another aspect of the invention is the charged particle beam processing method described above, wherein the straight lines oriented in different directions include two different diagonal straight portions and the method further comprises the steps of: determining intersection points of the straight portions from the stored image of the reference areas and the image of the reference areas formed during the process and calculating the amount of displacement between the intersection points; and applying the charged particle beam to the area to be processed corrected by the calculated amount of displacement between the intersection points for processing.

The invention provides a charged particle beam apparatus that utilizes charged particle beam irradiation to observe and process a workpiece, wherein the apparatus comprises:

image forming means that forms a workpiece pattern image based on the detected intensity of secondary charged particles emitted from the workpiece through irradiation of the charged particle beam; area specifying means that in the workpiece pattern image formed by the image forming means, specifies reference areas that contain, among contours of the workpiece pattern, at least two straight portions oriented in different directions, as well as an area to be processed; storage means that stores the areas specified by the area specifying means; scanning control means that controls the charged particle beam to be applied to the reference areas and the area to be processed specified by the area specifying means; calculation means that calculates the amount of positional displacement between the image of the reference areas stored in the storage means and the reference image formed by the image forming means during processing of the area to be processed; and control means that controls the scanning control means to apply the charged particle beam to the area to be processed corrected by the amount of displacement calculated by the calculation means.

The invention provides the following advantages:

(1) Even for workpieces having such fine patterns that drilling a hole at a certain point in the pattern on the workpiece with a charged particle beam may affect the performance of a semiconductor device when the pattern of the workpiece is transferred through exposure, drift correction can be carried out without affecting the performance of the resulting semiconductor device by providing a reference area that contains a contour of the workpiece pattern.

(2) As the present method uses a combination of a plurality of reference area that contain straight contours to determine the amount of displacement, a position in one direction only needs to be determined in one reference area. By thus limiting the image and the result to be determined, image processing for one reference area may be performed by simply adding pixel values in the contour line direction to stably determine the position, which can be used for an image with a poor signal-to-noise ratio. Since an image with a poor signal-to-noise ratio may be used, the period of time for which an irradiation beam is applied to the reference area can be reduced, resulting in reduced damage to the workpiece.

(3) When there is no pattern having a feature by which both the X and Y coordinates can be located, pattern matching cannot determine a point, so that drift correction cannot be carried out. However, the invention allows drift correction at least in a direction perpendicular to a contour line of an existing straight pattern. In general, this direction matches with the direction in which accuracy must be improved.

### BRIEF DESCRIPTION OF THE DRAWINGS

FIG. 1 is a block diagram showing the overall configuration of a charged particle beam apparatus.

FIG. 2 is a block diagram showing the configuration of the computer in FIG. 1.

FIG. 3 is a flowchart of the drift correction method.

FIG. 4 is a view for explaining how to calculate the position of a straight line.

FIG. 5 is a view for explaining how to determine the coordinate value of a reference position from a diagonal straight line.

FIG. 6 shows an example of selection of reference areas and an area to be processed.

FIG. 7 shows an example of selection of reference areas and an area to be processed.

FIG. 8 shows an example of selection of reference areas and an area to be processed.

FIG. 9 shows an example of selection of reference areas and an area to be processed.

FIG. 10 shows an example of selection of reference areas and an area to be processed.

FIG. 11 shows an example of selection of reference areas and an area to be processed.

### DETAILED DESCRIPTION OF THE PREFERRED EMBODIMENTS

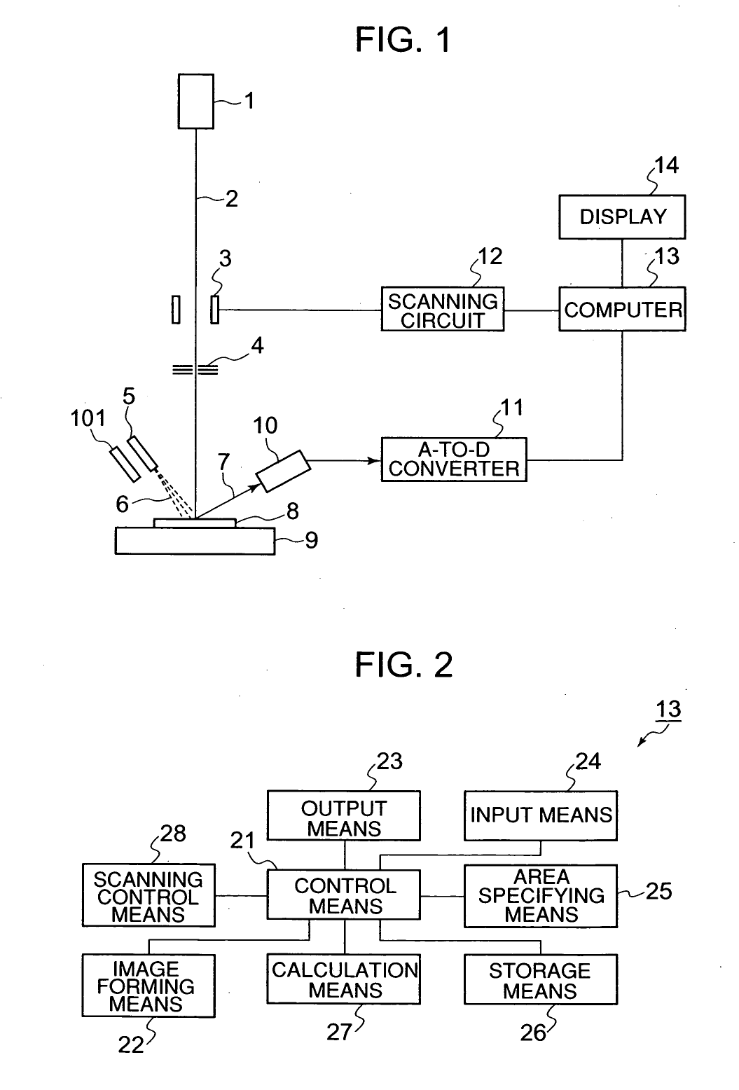

One embodiment of the invention will be described in detail below with reference to the drawings. FIG. 1 shows the overall configuration of a charged particle beam apparatus according to one embodiment of the invention. Reference number 1 denotes an ion source, which emits an ion beam 2. Reference number 3 denotes scanning electrodes including X and Y electrodes, which scan an irradiation spot over a predetermined range in the X-Y plane of a mask 8, which is a workpiece to which the ion beam 2 is applied. Reference number 4 denotes an objective lens that focuses the ion beam 2 into a spot on an object to be irradiated, which is the surface of the mask 8. Reference number 5 denotes a gas gun that sprays an organic compound vapor 6 onto a clear defect region on the mask 8 to deposit a light blocking film to repair the clear defect, while the ion beam 2 is selectively scanned and applied to the clear defect region.

To repair a opaque defect region, a gas gun 101 sprays an etching gas onto an unnecessary deposited portion, while the ion beam 2 is selectively applied to that portion to removed etching of that portion for repair. Reference number 9 denotes an X-Y stage, on which the mask 8 is mounted and moved in the X or Y direction. Reference number 10 denotes a detector that detects the intensity of secondary electrons 7 forced to be emitted from the surface of the mask 8 through irradiation of the ion beam 2. The two-dimensional intensity distribution of the secondary electrons corresponds to the pattern formed on the mask 8. Reference number 11 denotes an A-to-D converter that converts an analog measurement of the secondary electron intensity into digital data. The digital data is inputted in a computer 13, which reproduces an enlarged image of the pattern of the mask 8 and displays it on a display 14. Reference number 12 denotes a scanning circuit that receives an ion beam irradiation range from the computer 13 and controls the scanning electrodes 3.

FIG. 2 is a block diagram illustrating the internal configuration of the computer 13 shown in FIG. 1. Control means 21 includes a CPU (central processing unit) and various memories and performs various tasks, such as controlling various portions, temporarily storing data, and forwarding data. Image forming means 22 forms an image of a workpiece pattern of the mask 8 based on the intensity of the secondary electrons 7 detected by the detector 10. Output means 23 displays the image on the display 14. Input means 24 includes a keyboard and a mouse and functions to acquire information inputted by an operator. Area specifying means 25 specifies a plurality of reference areas that contain straight contours therein as well as an area to be processed where a defect is repaired. Storage means 26 stores various data. Calculation means 27 calculates the amount of displacement between a reference area image observed before processing and a reference area image observed as needed during processing. The amount of displacement represents the direction and magnitude of the displacement. The reference area is an area that is referenced to calculate the amount of displacement for drift correction (also referred to as “the amount of drift”). Scanning control means 28 controls the scanning circuit 12.

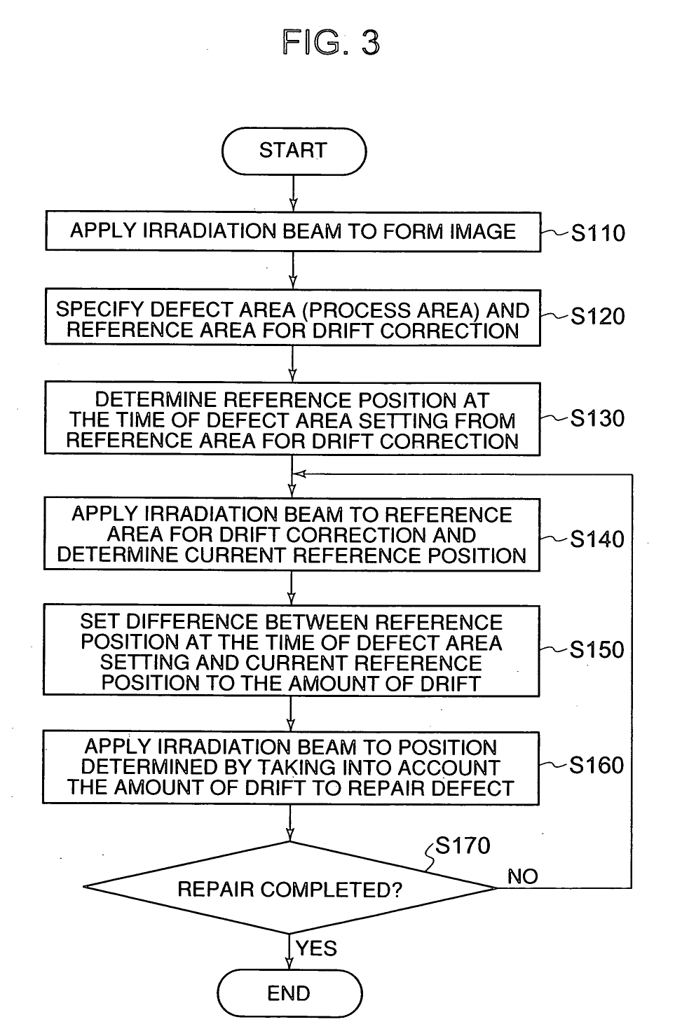

FIG. 3 is a flowchart showing a drift correction method used in the above charged particle beam apparatus. The mask 8 to be processed is irradiated with the ion beam 2, and the detector 10 detects the intensity of the secondary electrons 7 emitted from the mask 8. The image forming means 22 of the computer 13 acquires the intensity of the secondary electrons 7 detected by the detector 10 via the A-to-D converter 11 to form a workpiece pattern image. The output means 23 enlarges the formed image and displays it on the display 14 (step S110). On the workpiece pattern displayed on the display 14, the operator uses the input means 24, such as a mouse, to input a defect area, which is an area to be processed, as well as a rectangular reference area that contains a straight contour therein (step S120). The area specifying means 25 writes the defect area (process area) and the reference area specified by the operator as well as images of these areas onto the storage means 26. The calculation means 27 determines, from the straight contour in the reference area, a reference position used to calculate the amount of displacement and writes the reference position determined at the time of the defect area setting onto the storage means 26 (step S130). How to specifically determine a reference position will be described later.

To repair the defect area, the scanning control means 28 of the computer 13 controls the scanning circuit 12 to apply the ion beam 2 to the reference area, as required (step S140). Then, the detector 10 detects the intensity of secondary electrons 7 emitted from the mask 8 and the image forming means 22 of the computer 13 acquires the intensity of the detected secondary electrons 7 via the A-to-D converter 11 to form an image of the reference area. The calculation means 27 determines the current reference position from the reference area image formed in step 140 and compares it with the reference position at the time of the defect area setting determined in step S130 and stored in the storage means 26 to calculate the amount of drift, i.e., the amount of displacement (step S150). When the defect area is processed and repaired, the scanning control means 28 controls the scanning circuit 12 to apply the ion beam 2 onto a position calculated by taking into account the amount of drift calculated in step S150 (step S160). If the number of scans does not reach the number required for completing the process (step S170: NO), the process starting from step S140 is repeated as required. If the number of scans reaches the number required for completing the process (step S170: YES), the process is terminated.

Although the operator specifies the area to be processed in the above procedure, correct workpiece pattern data may be pre-stored on the storage means 26 in the computer 13 and the area specifying means 25 may compare the workpiece pattern read out from the storage means 26 with the workpiece pattern image composed in step S110 to find a mismatch location and set it as an area to be processed.

Description of how to calculate the amount of drift will follow. In the following description, a lateral position will be expressed by an X coordinate and a longitudinal position will be expressed by a Y coordinate. To calculate the amount of drift, the amount of lateral (X) drift and the amount of longitudinal (Y) drift are independently determined from the displacement of the reference position for lateral (X) position correction and the displacement of the reference position for longitudinal (Y) position correction, respectively, and the total amount of drift is then determined from the thus determined amounts of lateral (X) and longitudinal (Y) drift.

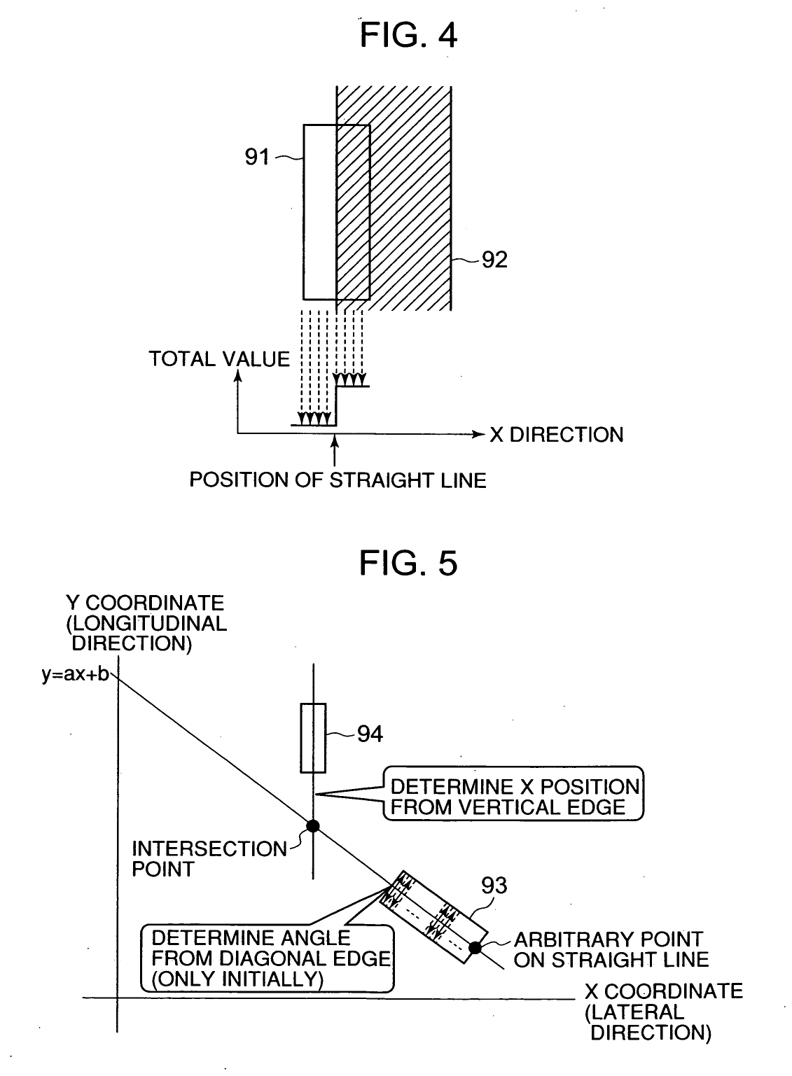

How to calculate the position of a straight line will be first described. FIG. 4 explains how to calculate the position of a straight line. To calculate the position of a straight line, the magnitude of a secondary electron signal is calculated for each of the pixels forming the image within a reference area to represent each of the pixels. For example, a value of 255 is assigned when the magnitude of the signal has a maximum value and a value of 0 is assigned when the magnitude of the signal has a minimum value. When a small area 91 contains a longitudinal straight contour perpendicular to the X axis, the magnitudes of the signals of the pixels having a same X coordinate (longitudinal position) are added in the direction of the straight line (the Y direction in this case). Then, the total values added for respective X coordinates are compared with each other to determine an X-coordinate position where the value abruptly changes and the X-coordinate position is set to the position of the straight line. Similarly, when the reference area contains a horizontal, lateral straight contour, values converted from the magnitudes of the signals of the pixels having a same Y coordinate (lateral position) are added and the values added for respective Y coordinates are compared with each other to determine a Y coordinate position where the value abruptly changes and the Y-coordinate position is set to the position of the straight line.

FIG. 5 explains how to determine a coordinate value of a reference position from a vertical straight line and a diagonal straight line.

When a reference area is set on a diagonal straight line, the displacement of the position of the straight line alone cannot tell whether the straight line is displaced in the X direction, or in the Y direction, or in both the X and Y directions. Therefore, a vertical straight line is used to fix an X coordinate and the Y coordinate of the intersection point of the diagonal straight line and the vertical straight line is used as a reference position, or a horizontal straight line is used to fix a Y coordinate and the X coordinate of the intersection point of the diagonal straight line and the horizontal straight line is used as a reference position.

The diagonal straight line can be expressed as y=ax+b.

Firstly, the slope a is determined. The slope a is only initially pre-determined using an image captured before drift correction. For example, the angle will be determined as follows: That is, in an area 93 that contains the diagonal straight line therein, the positions of the contour of the workpiece pattern are sequentially determined on a pixel basis in a direction perpendicular to the diagonal straight line. Then, the angle (slope) a of the straight line is determined from a sequence of points corresponding to the determined contour positions using least square approximation.

Then, the magnitudes of the signals indicating pixel values are added on a pixel basis in the straight line direction to find the position where the value abruptly changes. This determines the position of the straight line and hence the value of b.

The coordinate of the vertical straight line determined by the method described in the section [0021] using the scan area 94 set on the vertical straight line is substituted into the above determined equation in order to determine the coordinates of the intersection point.

For drift correction, the equation of the diagonal line will be obtained by using the slope a initially determined as described above and determining only the value of b, thereby determining the coordinates of the intersection point.

Examples of selected process areas and reference areas as well as how to calculate the amount of drift will now be described.

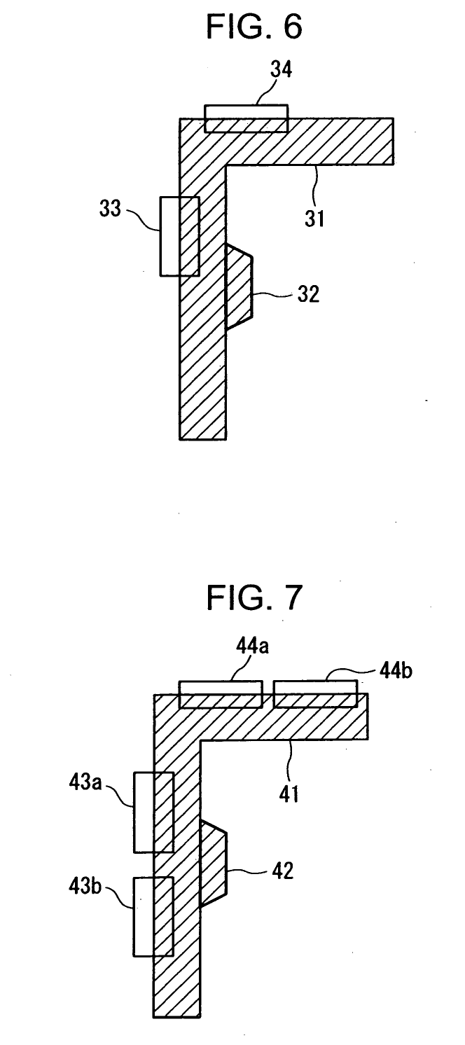

FIG. 6 shows an example in which reference areas are one area that contains a longitudinal straight contour and another area that contains a lateral straight contour.

In the figure, a pattern 31 on the workpiece includes the following specified areas; an area to be processed 32 that is a opaque defect to be repaired, a reference area 33 that contains a vertical, longitudinal straight contour, and a reference area 34 that contains a horizontal, lateral straight contour. It is assumed that a reference area is inputted in the computer 13 along with information on whether a straight contour portion in the reference area is either longitudinal or lateral.

The reference area 33 is used for lateral (X) position correction and the X coordinate position of a longitudinal straight line obtained from the contour within the reference area 33 will be a reference position. The amount of the lateral (X) drift is calculated based on the displacement of the reference position. The reference area 34 is used for longitudinal (Y) position correction and the Y coordinate position of a lateral straight line obtained from the contour within the reference area 34 will be a reference position. The amount of the longitudinal (Y) drift is calculated based on the displacement of the reference position. The amount of the lateral (X) drift obtained from the reference area 33 and the amount of the longitudinal (Y) drift obtained from the reference area 34 provide the total amount of drift.

FIG. 7 shows an example in which plurality of reference areas are used in succession.

In the figure, a pattern 41 on the workpiece includes the following specified areas; an area to be processed 42 that is a opaque defect to be repaired, reference areas 43a and 43b that contain a vertical, longitudinal straight contour and are used for lateral (X) position correction, and reference areas 44a and 44b that contain a horizontal, lateral straight contour and are used for longitudinal (Y) position correction.

For the loop from steps S140 to S170 in FIG. 3, from the first loop to a predetermined counted loop, the amount of drift will be determined by a method similar to FIG. 6 using the reference areas 43a and 44a, while from the next loop of the predetermined counted loop to the last loop, the amount of drift will be determined by a method similar to FIG. 6 using the reference areas 43b and 44b. Changing reference areas in succession in this way avoids damage to the pattern caused by multiple irradiation of the ion beam on a same reference area.

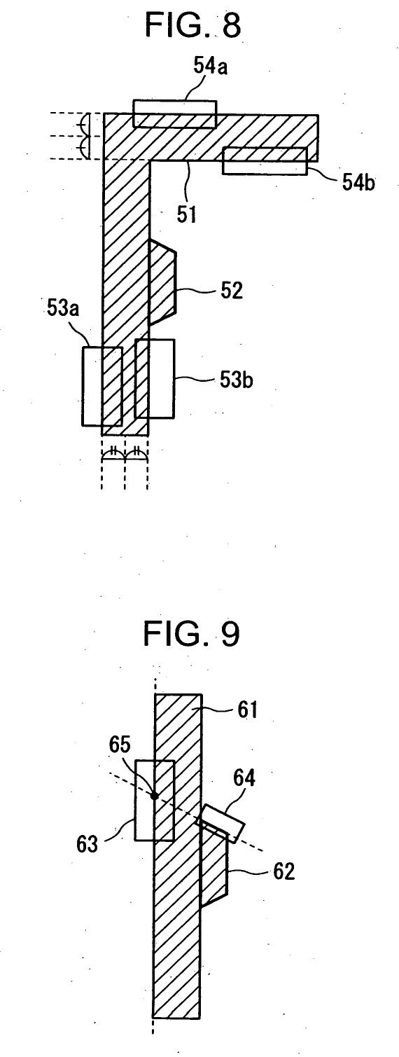

FIG. 8 shows an example in which the average position of two straight lines is used as a longitudinal position and the average position of other two straight lines is used as a lateral position.

In the figure, a pattern 51 on the workpiece includes the following specified areas; an area to be processed 52 that is a opaque defect to be repaired, reference areas 53a and 53b, each containing a vertical, longitudinal straight contour, and reference areas 54a and 54b, each containing a horizontal, lateral straight contour.

The reference areas 53a and 53b are used for lateral (X) position correction and the X coordinate position that is the average position of longitudinal straight lines obtained from the contours within the reference areas 53a and 53b will be a reference position. The reference areas 54a and 54b are used for longitudinal (Y) position correction and the Y coordinate position that is the average position of lateral straight lines obtained from the contours within the reference areas 54a and 54b will be a reference position.

FIG. 9 shows an example in which a diagonal straight line, instead of a lateral straight line, is used for longitudinal position correction.

In the figure, a pattern 61 on the workpiece includes the following specified areas; an area to be processed 62 that is a opaque defect to be repaired, a reference area 63 that contains a vertical, longitudinal straight contour, and a reference area 64 that contains a diagonal straight contour. A contour of the area to be processed 62 is used as the diagonal straight portion in the reference area 64.

The reference area 63 is used for lateral (X) position correction and the X coordinate position of a longitudinal straight line obtained from the contour within the reference area 63 will be a reference position. The reference area 64 is used for longitudinal (Y) position correction and the Y coordinate position of an intersection point 65 of the diagonal straight line obtained from the contour within the reference area 64 and the straight line obtained from the contour within the reference area 63 will be a reference position. If part of a contour of an area to be processed is used to calculate a reference position as in FIG. 9, that contour portion will be the last processed portion. This reference area setting method is effective when there are only vertical patterns in the simultaneously displayable region of the output means 23.

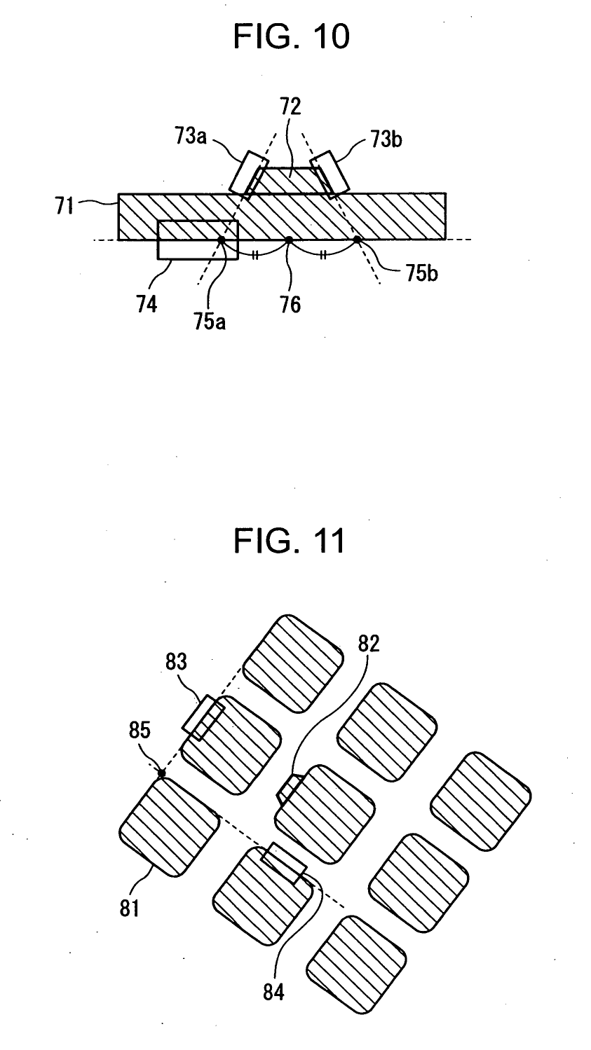

FIG. 10 shows an example in which two diagonal straight lines are used for lateral position correction.

In the figure, a pattern 71 on the workpiece includes the following specified areas; an area to be processed 72 that is a opaque defect to be repaired, a reference area 74 that contains a horizontal, lateral straight contour, and reference areas 73a and 73b, each containing a diagonal straight contour. Contours of the area to be processed 72 are used as diagonal straight portions in the reference areas 73a and 73b.

The reference area 74 is used for longitudinal (Y) position correction and the Y coordinate position of a lateral straight line obtained from the contour within the reference area 74 will be a reference position. The reference areas 73a and 73b are used for lateral (X) position correction. An intersection point 75a of the diagonal straight line obtained from the contour within the reference area 73a and the lateral straight line obtained from the contour within the reference area 74, as well as an intersection point 75b of the diagonal straight line obtained from the contour within the reference area 73b and the lateral straight line obtained from the contour within the reference area 74 are determined, and a midpoint 76 between the intersection points 75a and 75b is determined. The X coordinate position of the midpoint 76 will be the reference position for lateral (X) position correction.

This method is effective when there are only horizontal patterns in the simultaneously displayable region of the output means 23. The contour portion of the area to be processed used to calculate the reference position will be the last processed portion.

FIG. 11 shows an example in which reference areas are two areas that contain diagonal straight contours different from each other.

In the figure, a pattern 81 on the workpiece includes the following specified areas; an area to be processed 82 that is a opaque defect to be repaired, a reference area 83 that contains a diagonal straight contour, and a reference area 84 that contains a diagonal straight contour that is nearly perpendicular to the straight contour within the reference area 83. Both of them are used for diagonal positions corrections.

In this case, an intersection point 85 of a straight line obtained from the contour within the reference area 83 and a straight line obtained from the contour within the reference area 84 will be a reference position. The amount of lateral (X) drift and the amount of longitudinal (Y) drift are calculated based on displacement of the reference position.

When there are only vertical patterns in the region displayed by the output means 23, a reference area may be an area that contains a vertical straight contour alone. In the case where there are only vertical patterns, correction of only horizontal displacement can prevent horizontally displaced processing. Similarly, when there are only horizontal patterns in the region displayed by the output means 23, a reference area may be an area that contains a horizontal straight contour alone to correct only vertical displacement.

For example, in the case of a protrusion defect, there are an area to be processed contour line formed of a defect image contour line (which is referred to as W) and an area to be processed contour line formed of a reference image contour line (which is referred to as C). When C and W are compared, C is required to be processed more precisely than W. Although in repairing a protrusion defect, it is conceivable that there are, for example, only vertical contours and there is a direction in which drift correction cannot be carried out, the direction in which the accuracy of C is improved (a direction perpendicular to C) and the direction in which drift correction can be carried out coincide.

In the above embodiments, although the charged particle beam apparatus is an ion beam irradiation apparatus, it may be an electron beam irradiation apparatus.

The computer 13 has a computer system therein. The operation process of the image forming means 22, the area specifying means 25, the calculation means 27 and the scanning control means 28 described above is stored on a computer readable recording medium in the form of a program. The computer system reads out the program and executes it to perform the above process. The computer system used herein includes an OS and hardware, such as peripheral devices.

The “computer system” includes, if it uses the WWW system, a website providing environment (or displaying environment).

The “computer readable recording medium” is a portable medium such as a flexible disc, magneto-optical disc, ROM and CD-ROM, and a storage device, such as a hard disk, built in the computer system. Furthermore, the “computer readable recording medium” may also include a medium that dynamically holds a program for a short period of time, such as a communication line when a program is transmitted via a network such as the Internet or a communication network such as a telephone network, and a medium that holds a program for a fixed period of time, such as a volatile memory in a computer system serving as a server or client in the above situation. The program may be a program that accomplish part of the above functions, or may be a program that can accomplish the above functions in combination with a program that has been already stored in the computer system.

What is claimed is:

1. A charged particle beam processing method using a charged particle beam apparatus that utilizes charged particle beam irradiation to observe and process a workpiece comprising the steps of:
forming a workpiece pattern image based on the detected intensity of secondary charged particles emitted from the workpiece through irradiation of the charged particle beam;
in the formed workpiece pattern image, specifying and storing reference areas that contain, among contours of the workpiece pattern, at least two straight portions oriented in different directions, as well as an area to be processed;
applying the charged particle beam to the reference areas during the process as required and forming an image of the reference areas based on the detected intensity of secondary charged particles emitted from the reference areas;
calculating the amount of positional displacement between the stored image of the reference areas and the image of the reference areas formed during the process; and
applying the charged particle beam to the area to be processed corrected by the calculated amount of displacement for processing.

2. The charged particle beam processing method according to claim 1, wherein the straight lines oriented in different directions include a lateral straight portion and a longitudinal straight portion and
the method further comprises the step of calculating the amount of longitudinal displacement determined from the displacement of the lateral straight portion and the amount of lateral displacement determined from the longitudinal straight portion.

3. The charged particle beam processing method according to claim 1, wherein the method further comprises the steps of:
determining intersection points of the straight portions from the stored image of the reference areas and the image of the reference areas formed during the process and calculating the amount of displacement between the intersection points; and
applying the charged particle beam to the area to be processed corrected by the calculated amount of displacement between the intersection points.

4. The charged particle beam processing method according to claim 1, wherein a plurality of parts of the straight portions is used in the reference areas.

5. The charged particle beam processing method according to claim 2, wherein the reference areas contain one lateral straight portion and a plurality of longitudinal straight portions, or a plurality of lateral straight portions and one longitudinal straight portion, and
the method further comprises the step of calculating the amount of lateral displacement from the average position of the intersection points of the one lateral straight line and the plurality of longitudinal straight lines, or the amount of longitudinal displacement from the average position of the intersection points of the one longitudinal straight line and the plurality of lateral straight lines.

6. The charged particle beam processing method according to claim 2, wherein the reference areas contain parallel, lateral straight portions or parallel, longitudinal straight portions, and
the method further comprises the step of calculating the amount of longitudinal displacement from the average position of the parallel, lateral straight lines or the amount of lateral displacement from the average position of the parallel, longitudinal straight lines.

7. The charged particle beam processing method according to claim 1, wherein the straight lines oriented in different directions include two different diagonal straight portions, and
the method further comprises the steps of:
determining intersection points of the straight portions from the stored image of the reference areas and the image of the reference areas formed during the process and calculating the amount of displacement between the intersection points; and
applying the charged particle beam to the area to be processed corrected by the calculated amount of displacement between the intersection points for processing.

8. A charged particle beam apparatus that utilizes charged particle beam irradiation to observe and process a workpiece, wherein the apparatus comprising:
image forming means for forming workpiece pattern image based on the detected intensity of secondary charged particles emitted from the workpiece through irradiation of the charged particle beam;
area specifying means for in the workpiece pattern image forming by the image forming means, specifies reference areas that contain, among contours of the workpiece pattern, at least two straight portions oriented in different directions, as well as an area to be processed;
storage means for storing the areas specified by the area specifying means;
scanning control means for controlling the charged particle beam to be applied to the reference areas and the area to be processed specified by the area specifying means;
calculation means for calculating the amount of positional displacement between the image of the reference areas stored in the storage means and the reference image formed by the image forming means during processing of the area to be processed; and
control means for controlling the scanning control means to apply the charged particle beam to the area to be processed corrected by the amount of displacement calculated by the calculation means.
